(19) United States
(12) Patent Application Publication
(10) Pub. No.: US 2008/0063743 A1
(43) Pub. Date: Mar. 13, 2008

(54) Insert-molding mold

(75) Inventors: Ching-Cheng Wang, Tao Yuan Shien (TW); Yun-Liang Hsieh, Tao Yuan Shien (TW); Jung-Wen Chang, Tao Yuan Shien (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 11/819,998

(22) Filed: Jun. 29, 2007

(30) Foreign Application Priority Data
Sep. 7, 2006 (TW) 95133104

(51) Int. Cl. B28B 21/88

(52) U.S. Cl. 425/468

(57) ABSTRACT

An insert-molding mold to combine an inserted piece and a plastic as a product includes a male mold, a female mold, and at least one adjustable support structure. The insert-molding mold may fit different inserted pieces with different thickness. The male mold includes a male mold body, and a male mold core disposed in the male mold body. The inserted piece has an inserted piece thickness. A distance may be generated between the female mold and the male mold core when the male mold matching with the female mold. The distance is larger than the inserted piece thickness. The support structure of the insert-molding mold may support the male mold core and adjust the distance between the female mold and the male mold core to fit the inserted piece thickness.

### RELATED APPLICATIONS

This application claims priority to Taiwan Application Serial Number 95133104, filed Sep. 7, 2006, which is herein incorporated by reference.

### BACKGROUND

1. Field of Invention

The present invention relates to an insert-molding mold. More particularly, the present invention relates to an insert-molding mold for fitting different inserted pieces with different thickness.

2. Description of Related Art

Insert-molding molding is used widely in manufacturing, especially for combining two materials with different properties. Referring to FIG. 1, which illustrates a sectional view diagram of an insert-molding mold of prior art. The insert-molding mold 100 includes a male mold 110 and a female mold 120 to combine an inserted piece 140 and a plastic 150 as a product. The male mold 110 has a male mold body 112, and a male mold core 114 disposed in the male mold body 112. The female mold 120 has a raised female mold wall 124. The inserted piece 140 is clipped between the male mold core 114 and the female mold 120 and a reserved space 130 is formed between the male mold 110 and the female mold 120. The reserved space 130 surrounds the inserted piece 140. The plastic 150 may be inserted into the reserved space 130 though a plastic inlet 122 and combined with the inserted piece 140. The female mold wall 124 of the female mold 120 is compactly connected with the male mold body 112 to prevent the plastic 150 from leaking out. The female mold 120 is opened after the plastic 150 hardens. There is a lifting plate 160 disposed under the male mold 110 and there are a plurality of lifting needles 162 connected with the lifting plate 160 and crossed through the male mold 110. The lifting plate 160 is moved and the lifting needles 162 connected with the lifting plate 160 are lifted to lift the product.

The male mold core of the traditional insert-molding mold may not be adjusted for different inserted piece with different inserted piece thickness. However, sometimes there is a need to use a different inserted piece with a different thickness, and the insert-molding mold needs to be altered. For example, if the thickness of the inserted piece was increased, a miller, lathe or grinder can decrease the thickness of the male mold core to fit the increased thickness of the inserted piece. If the thickness of the inserted piece thickness were decreased, the male mold core would be repair welded to increase the thickness of the male mold core to fit the thickness of the inserted piece and the male mold core would also be milled, lathed, or grinded to flatten a surface of the male mold core.

For the forgoing reasons, there is a need for an adjustable insert-molding mold to fit different inserted pieces with different thickness.

### SUMMARY

The invention provides an insert-molding mold for fitting different inserted pieces with different thickness. The insert-molding mold may combine an inserted piece and plastic as a product. The insert-molding mold includes a female mold, a male mold, and at least one adjustable support structure. The male mold has a male mold body, and a male mold core. The male mold core is disposed in the male mold body. The inserted piece has an inserted piece thickness. A distance is generated between the male mold core and the female mold when the female mold closes to the male mold. The distance is larger than the inserted piece thickness. The adjustable support structure may adjust the distance between the female mold and the male mold core to be as same as the inserted piece thickness.

The invention also provides an insert-molding mold to combine an inserted piece and a plastic as a product. The insert-molding mold includes a female mold, a male mold, a base plate, a plurality of partitions, and at least one adjustable support structure. The male mold has a male mold body, and a male mold core. The male mold core is disposed in the male mold body and the inserted piece has an inserted piece thickness. The partitions are disposed between the male mold body and the base plate to form a space between the male mold body and the base plate. A distance is generated between the male mold core and the female mold when the female mold closes to the male mold. The distance is larger than the inserted piece thickness. The adjustable support structure may adjust the distance between the female mold and the male mold core to be the same as the inserted piece thickness.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a sectional view diagram of the insert-molding mold of the prior art;

FIG. 2 is a sectional view diagram of a first embodiment of the insert-molding mold of this invention;

FIG. 3 is a sectional view diagram of a second embodiment of the insert-molding mold of this invention;

FIG. 4 is a sectional view diagram of a third embodiment of the insert-molding mold of this invention; and

FIG. 5 is a sectional view diagram of a fourth embodiment of the insert-molding mold of this invention.

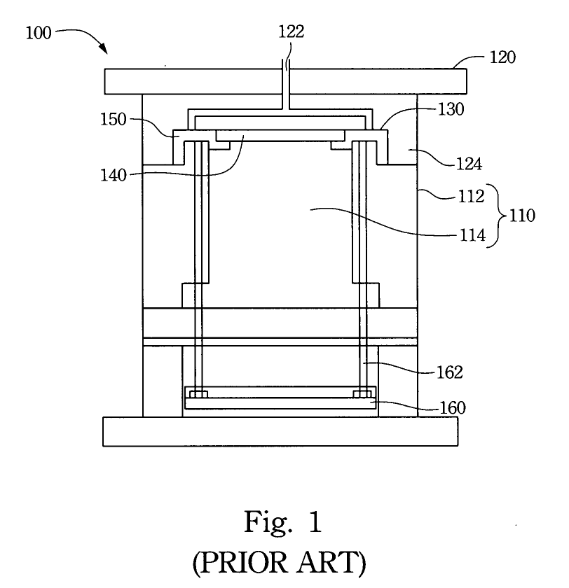

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

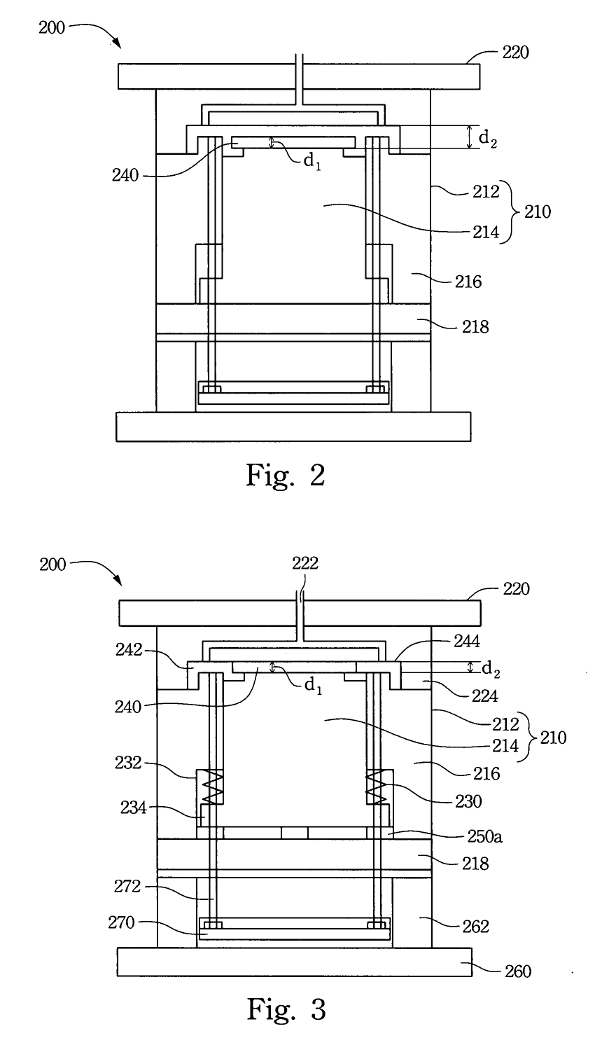

Refer to FIG. 2. FIG. 2 illustrates a sectional view diagram of a first embodiment of an insert-molding mold of the invention. The insert-molding mold 200 is made of a male mold 210 and a female mold 220. The male mold 210 includes a male mold body 212 and a male mold core 214. The male mold core 214 is disposed in the male mold body 212. The male mold body 212 has a male mold wall 216 and a male mold bottom 218. A side of the male mold core 214 near the female mold 220 is compactly connected with the male mold wall 216. An inserted piece 240 with an inserted piece thickness d1 is disposed on the male mod core 214. A distance d2 is generated between the male mold core 214 and the female mold 220 when the male mold 210 matches the female mold 220. The distance d2 is larger than the inserted piece thickness d1.

Refer to FIG. 3. FIG. 3 illustrates a sectional view diagram of a second embodiment of the insert-molding mold of the invention. The insert-molding mold 200 may utilize at least one adjustable support structure 250a to adjust the distance d2 between the male mold core 214 and the female 220. The distance d2 is adjusted to be the same as the inserted piece thickness d1. The inserted piece 240 is clipped between the male mold core 214 and the female mold 220. The female mold 220 has a female mold wall 224 to form a reserved space 244 between the male mold 210 and the female mold 220. The reserved space 244 surrounds the inserted piece 240. The female mold 220 has at least one plastic inlet 222 leading to the reserved space 244. A plastic 242 may be inserted into the reserved space 244 surrounding the inserted piece 240 via the plastic inlet 222. The plastic 242 may combine with the inserted piece 240 as a product. The adjustable support structure 250a may be a block disposed between the male mold bottom 218 and the male mold core 214 to adjust the distance d2. The blocks of the adjustable support structure 250a may have different thicknesses to fit different inserted piece thicknesses d1 and may adjust the distance d2 to be the same as the inserted piece thickness d1.

The insert-molding mold 200 may further include a base plate 260 and a plurality of partitions 262. The base plate 260 is fixed on the ground and the partitions 262 are disposed between the base plate 260 and the male mold 210 to form a space between the male mold 210 and the base plate 260. The insert-molding mold 200 may further include a lifting plate 270 and a plurality of lifting needles 272. The lifting plate 270 is disposed between the male mold 210 and the base plate 260. An end of each lifting needle 272 is fixed on the lifting plate 270; another end of each lifting needle 272 is passed through the male mold 210 to be in contact with the product. The female mold 220 may be opened when the plastic is hard. Then, the formed product may be lifted by lifting the lifting plate 270 and the lifting needles 272 contacted with the product.

The male mold body 212 may have a cavity 232 disposed at a boundary between the male mold wall 216 and the male mold bottom 218. The male mold core 214 may have a flange 234 raised on a side of the male mold core 214 near the male mold bottom 218. The flange 234 may slide in the cavity 232 by adjusting the adjustable support structure 250a. The insert-molding mold 200 may further include a plurality of elastic devices 230. The elastic devices 230 are disposed between the cavity 232 and the flange 234 near the female mold 220. The male mold core 214 may be secured by the adjustable support structure 250a and the elastic devices 230. The elastic devices 230 may be a plurality of springs.

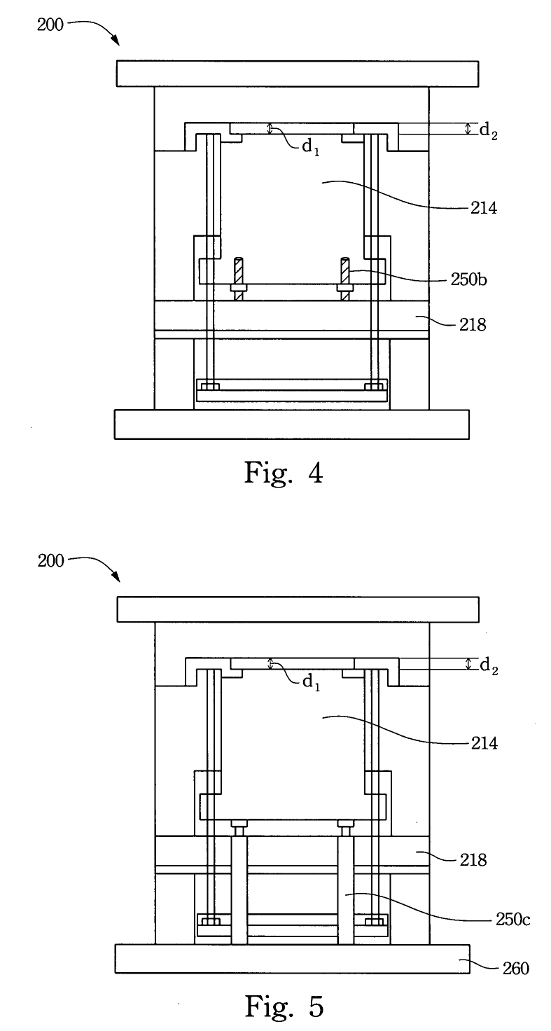

Other devices with similar functions may replace the adjustable support structure 250a. For example, as shown in FIG. 4, the adjustable support structure 250b may be at least a screw. An end of each screw may be fixed on the male mold bottom 218 (or on the base plate 270); another end of each screw may insert into the male mold core 214. The screw of the adjustable support structure 250b has a nut to support the male mold core 214. The distance d2 between the male mold core 214 and the female mold 220 is adjusted to fit different inserted pieces with different thickness d1 by a different position of the nut on the screw. The screw of the adjustable support structure 250b may be a ball screw. As shown in FIG. 5, the adjustable support structure 250c may also be a pneumatic cylinder or an oil cylinder. An end of the pneumatic cylinder or the oil cylinder of the adjustable support structure 250c may be fixed on the base plate 260. Another end of the adjustable support structure 250c may be connected to the male mold core 214 via the male mold bottom 218. The distance d2 between the male mold core 214 and the female mold 220 may be adjust to fit different inserted pieces with different thickness d1 by controlling the pneumatic cylinder or the oil cylinder of the adjustable support structure 250c in the embodiment of the insert-molding mold.

The insert-molding mold may generate the distance larger than the inserted piece between the male mold core and the female mold. Then, the distance may be adjusted by the adjustable support structure to be as same as the inserted piece thickness. Compared with the traditional complex process on the male mold core such as milling or repair welding, the insert-molding mold may easily adjust the distance between the male mold core and the female by the adjustable support structure and may save cost and processing time.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An insert-molding mold for fitting different inserted pieces with different thickness and combining a plastic and an inserted piece as a product comprising:
a female mold;
a male mold comprising a male mold body, and a male mold core, wherein the male mold core is disposed in the male mold body and the inserted piece has an inserted piece thickness, whereby a distance is generated between the male mold core and the female mold when the female mold matching with the male mold, wherein the distance is larger than the inserted piece thickness; and
at least one adjustable support structure to adjust the distance between the female mold and the male mold core to be as same as the inserted piece thickness.

2. The insert-molding mold of claim 1, wherein the adjustable support structure is at least a block having a block thickness; the male mold body has a male mold bottom and the block is disposed between the male mold bottom and the male mold core, whereby the distance between the male mold core and the female mold is adjusted to be as same as the inserted piece thickness by the block thickness of the block.

3. The insert-molding mold of claim 1, wherein the adjustable support structure is at least a screw and the male mold body has a male mold bottom; an end of the screw is fixed on the male mold bottom and another end of the screw is inserted into the male mold core; the screw further has a nut to support the male mold core, whereby the distance between the male mold core and the female mold is adjusted different position of the nut on the screw.

4. The insert-molding mold of claim 1, wherein the inserted piece is clipped between the male mold core and the female mold; the female mold has a female mold wall to form a reserved space, wherein the reserved space surrounds the inserted piece.

5. The insert-molding mold of claim 4, wherein the female mold comprises a plastic inlet leading to the reserved space, wherein the plastic is inserted into the reserved space through the plastic inlet and combines with the inserted piece as the product.

6. The insert-molding mold of claim 1, wherein the male mold body comprises a male mold wall, a male mold bottom, and a cavity disposed at a boundary between the male mold wall and the male mold bottom; the male mold core has a flange disposed near the male mold bottom, whereby the flange of the male mold core is moved in the cavity by the adjustable support structure.

7. The insert-molding mold of claim 6, wherein the insert-molding mold comprises a plurality of elastic devices disposed between the cavity and the flange near the female mold to secure the male mold core.

8. The insert-molding mold of claim 7, wherein the elastic devices are a plurality of springs.

9. An insert-molding mold for fitting different inserted pieces with different thickness and combining a plastic and an inserted piece as a product comprising:
a female mold;
a male mold comprising a male mold body, and a male mold core, wherein the male mold core is disposed in the male mold body and the inserted piece has an inserted piece thickness, whereby a distance is generated between the male mold core and the female mold when the female mold matching with the male mold, wherein the distance is larger than the inserted piece thickness;
at least an adjustable support structure to adjust the distance between the female mold and the male mold core to be as same as the inserted piece thickness;
a base plate; and
a plurality of partitions disposed between the male mold body and the base plate to form a space between the male mold body and the base plate.

10. The insert-molding mold of claim 9, wherein the adjustable support structure is at least a block having a block thickness; the male mold body has a male mold bottom and the block is disposed between the male mold bottom and the male mold core, whereby the distance between the male mold core and the female mold is adjusted to be the same as the inserted piece thickness by the block thickness of the block.

11. The insert-molding mold of claim 9, wherein the adjustable support structure is at least a screw and the male mold body has a male mold bottom; an end of the screw is fixed on the base plate and another end of the screw is inserted into the male mold core via the male mold bottom; the screw further has a nut to support the male mold core, whereby the distance between the male mold core and the female mold is adjusted by the different position of the nut on the screw.

12. The insert-molding mold of claim 11, wherein the screw is at least a ball screw.

13. The insert-molding mold of claim 9, wherein the adjustable support structure is at least a pneumatic cylinder and the male mold body has a male mold bottom; an end of the pneumatic cylinder is fixed on the base plate and another end of the pneumatic cylinder is connected to the male mold core via the male mold bottom, whereby the distance between the male mold core and the female mold is adjusted by controlling the pneumatic cylinder connected to the male mold core.

14. The insert-molding mold of claim 9, wherein the adjustable support structure is at least an oil cylinder and the male mold body has a male mold bottom; an end of the oil cylinder is fixed on the base plate and another end of the oil cylinder is connected to the male mold core via the male mold bottom, whereby the distance between the male mold core and the female mold is adjusted by controlling the oil cylinder connected to the male mold core.

15. The insert-molding mold of claim 9, wherein the inserted piece is clipped between the male mold core and the female mold; the female mold has a female mold wall to form a reserved space, wherein the reserved space is surrounding the inserted piece.

16. The insert-molding mold of claim 15, wherein the female mold comprises a plastic inlet leading to the reserved space, wherein the plastic is inserted into the reserved space through the plastic inlet and combine with the inserted piece as the product.

17. The insert-molding mold of claim 16, wherein the insert-molding mold comprises a lifting plate and a plurality of lifting needles; the lifting plate is disposed between the male mold body and the base plate; an end of each needle is fixed on the lifting plate and another end of each needle is passed through the male mold and is in contact with the product, whereby the female mold is opened and the lifting plate is moved to lift the lifting needles and the product is lifted.

18. The insert-molding mold of claim 9, wherein the male mold body comprises a male mold wall, a male mold bottom, and a cavity disposed at the boundary between the male mold wall and the male mold bottom; the male mold core has a flange disposed near the male mold bottom, whereby the flange of the male mold core is slid in the cavity by the adjustable support structure.

19. The insert-molding mold of claim 18, wherein the insert-molding mold comprises a plurality of elastic device disposed between the cavity and the flange near the female mold to secure the male mold core.

20. The insert-molding mold of claim 19, wherein the elastic devices are a plurality of springs.
